(19) United States
(12) Patent Application Publication
(10) Pub. No.: US 2011/0082685 A1
(43) Pub. Date: Apr. 7, 2011

(54) PROVISIONING TEXT SERVICES BASED ON ASSIGNMENT OF LANGUAGE ATTRIBUTES TO CONTACT ENTRY

(75) Inventors: Eskil Ahlin, Lund (SE); Richard Bunk, Veberod (SE); Sven-Olof Karlsson, Malmo (SE)

(73) Assignee: SONY ERICSSON MOBILE COMMUNICATIONS AB, Lund (SE)

(21) Appl. No.: 12/774,910

(22) Filed: May 6, 2010

Related U.S. Application Data
(60) Provisional application No. 61/248,630, filed on Oct. 5, 2009.

(51) Int. Cl. G06F 17/20

(52) U.S. Cl. 704/8

(57) ABSTRACT

A method including establishing a voice communication with another user; performing voice analysis to determine a language being used by a user during the voice communication; generating a language attribute that indicates the language; assigning or associating the language attribute to a contact entry or a separate list associated with the other user; receiving a request to create a text communication to the other user; and providing text services corresponding to the language attribute associated with the other user, wherein the text services include a script system to permit the user to create the text communication.

### BACKGROUND

With the development of user devices, such as mobile phones and personal digital assistants (PDAs), users may use various modes of communication (e.g., voice, text, video, etc.) to communicate anywhere and anytime. Further, given the global reach of communication, more and more users are communicating in more than one language.

### SUMMARY

According to an exemplary implementation, a method may comprise establishing, by a voice communication with another user; performing voice analysis to determine a language being used by a user during the voice communication; generating a language attribute that indicates the language; assigning or associating the language attribute to a contact entry associated with the other user; receiving a request to create a text communication to the other user; and providing text services corresponding to the language attribute associated with the other user, wherein the text services include a script system to permit the user to create the text communication.

Additionally, the method may comprise selecting the contact entry based on an inbound communication address or an outbound communication address associated with the other user.

Additionally, the method may comprise providing one or more of auto-correction, word prediction, or spell checking in accordance with the language attribute.

Additionally, the method may comprise providing the text services as a part of a multilingual text communication application.

Additionally, the text communication may comprise one of an e-mail, a simple messaging service message, or a multimedia messaging service message.

Additionally, the method may comprise creating a contact entry associated with the other user when one does not already exist.

Additionally, the voice communication may comprise one of a telephone call, a voice chat, or a voice multimedia messaging service message.

Additionally, the script system may comprise an alphabetic and directionality system corresponding to the language attribute.

According to another exemplary implementation, a user device may comprise components configured to perform voice analysis to determine a language being used by a user during a voice communication with another user; generate a language attribute that indicates the language; assign or associate the language attribute to a contact entry associated with the other user; receive a request to create a text communication to the other user; and provide a script system in correspondence to the language attribute to permit the user to create the text communication in the language.

Additionally, the user device may comprise a radio telephone.

Additionally, when performing voice analysis, the user device may determine the language even when the user speaks more than one language during the voice communication.

Additionally, the user device may store a contacts list; create a separate list entry corresponding to the language attribute, and select the contact entry from the contact list based on an inbound communication address or an outbound communication address associated with the other user.

Additionally, the text communication may comprise one of an e-mail, a simple messaging service message, or a multimedia messaging service message.

Additionally, the user device may perform voice analysis to identify a language being used by the other user.

Additionally, the user device may create a contact entry associated with the other user when one does not already exist.

Additionally, the user device may provide one or more of auto-correction, word prediction, or spell checking in accordance with the language attribute.

According to still another implementation, a computer-readable medium may contain instructions executable by at least one processing system. The computer-readable medium may store the instructions to perform voice analysis to determine a language being used by a user during a voice communication with another user; generate a language attribute that indicates the language; assign or associate the language attribute to a contact entry associated with the other user; receive a request to create a text communication to the other user; and provide text services in correspondence to the language attribute to permit the user to create the text communication in the language.

Additionally, the computer-readable medium may store one or more instructions to store a contacts list; store a language attribute list; and select the contact entry from the contact list.

Additionally, the computer-readable medium may store one or more instructions to provide the text services as a part of a multilingual text communication application.

Additionally, wherein a user device in which the computer-readable medium resides comprises a radio telephone.

### BRIEF DESCRIPTION OF THE DRAWINGS

The accompanying drawings, which are incorporated in and constitute a part of this specification, illustrate exemplary embodiments described herein and, together with the description, explain these exemplary embodiments. In the drawings:

FIGS. 1A-1F are diagrams illustrating an exemplary environment in which an exemplary embodiment of provisioning text services based on an assignment of a language attribute to a user's contact entry may be implemented;

FIG. 2 is a diagram illustrating an exemplary user device in which exemplary embodiments described herein may be implemented;

FIG. 3 is a diagram illustrating exemplary components of the user device;

FIG. 4 is a diagram illustrating exemplary functional components of the user device;

FIGS. 5A-5D are diagrams illustrating exemplary processes performed by the functional components; and

FIGS. 6A and 6B are flow diagrams illustrating an exemplary process for provisioning text services based on an assignment of a language attribute to a user's contact entry.

### DETAILED DESCRIPTION

The following detailed description refers to the accompanying drawings. The same reference numbers in different drawings may identify the same or similar elements. Also, the following description does not limit the invention, which is defined by the claims.

### OVERVIEW

According to an exemplary embodiment, when a multilingual user conducts a voice communication (e.g., a telephone call, a voice chat, a voice multimedia messaging service (MMS) message, or the like) with another user, a user device may analyze the voice communication to determine a language (e.g., English, Swedish, German, Japanese, etc.) used by the multilingual user. The user device may then generate a language attribute that indicates the language, and assign or associate the language attribute to a contact entry associated with the other user, which may, for example, be included in a contact list stored on the user device, or a separate list associated with the other user. When the multilingual user initiates a text communication (e.g., an e-mail, a simple messaging service (SMS) message, an MMS message, or the like) to the other user, the user device may automatically provide text services in correspondence to the language indicated by the language attribute. By way of example, but not limited thereto, the text services may include a script system (e.g., alphabetic characters, directionality, segmentation, etc.), and one or more of spell-checking, word suggestion, or auto-correction in accordance with the language. In this way, among other things, a multilingual user may not need to select an appropriate language for communicating the text communication to another user

### EXEMPLARY ENVIRONMENT

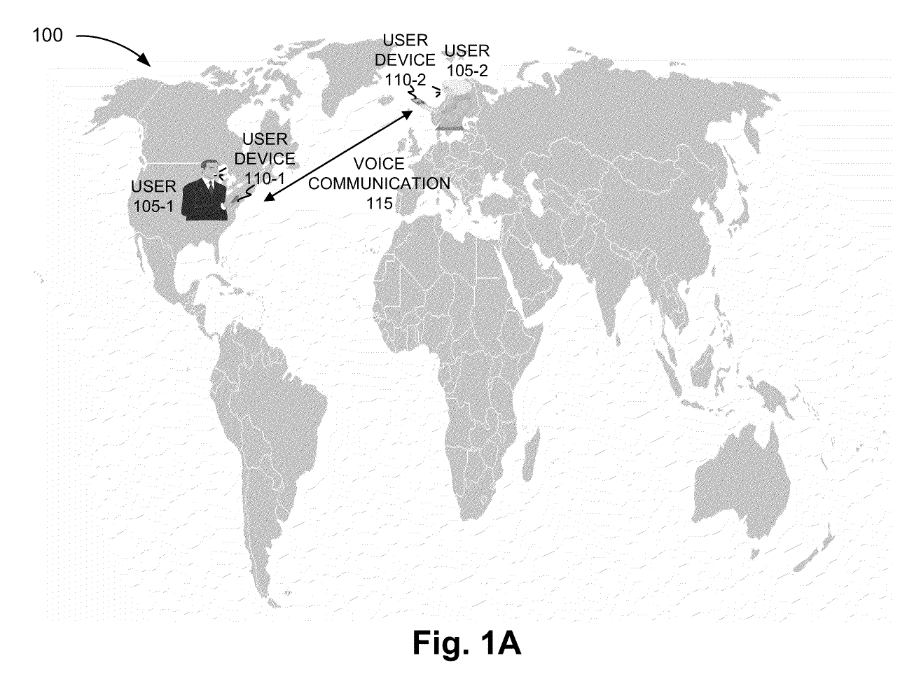

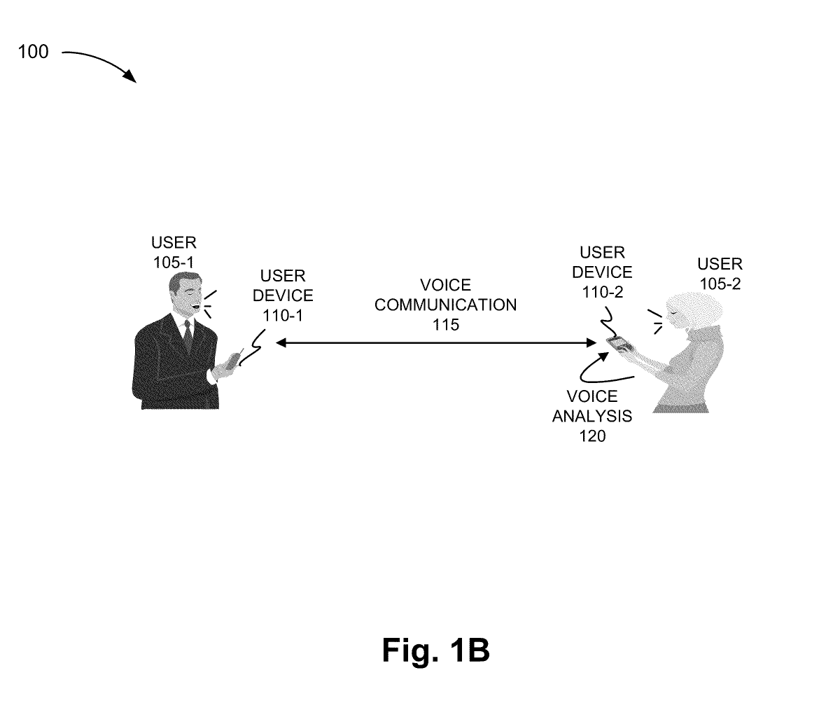

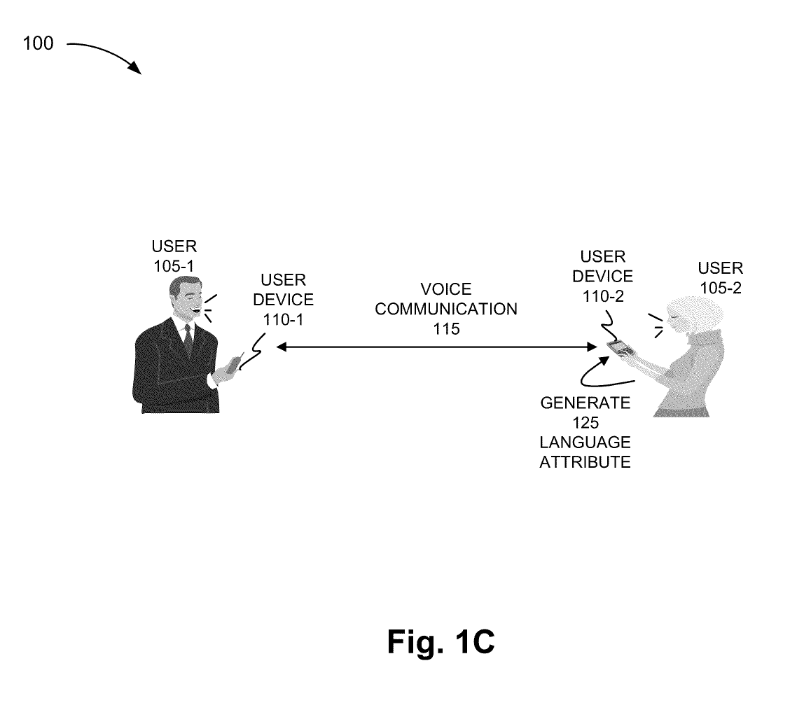

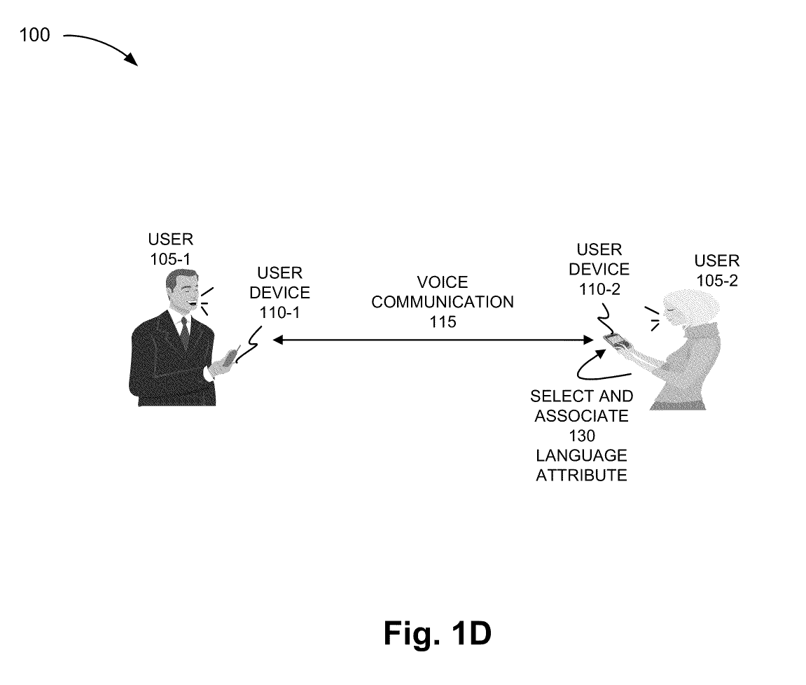

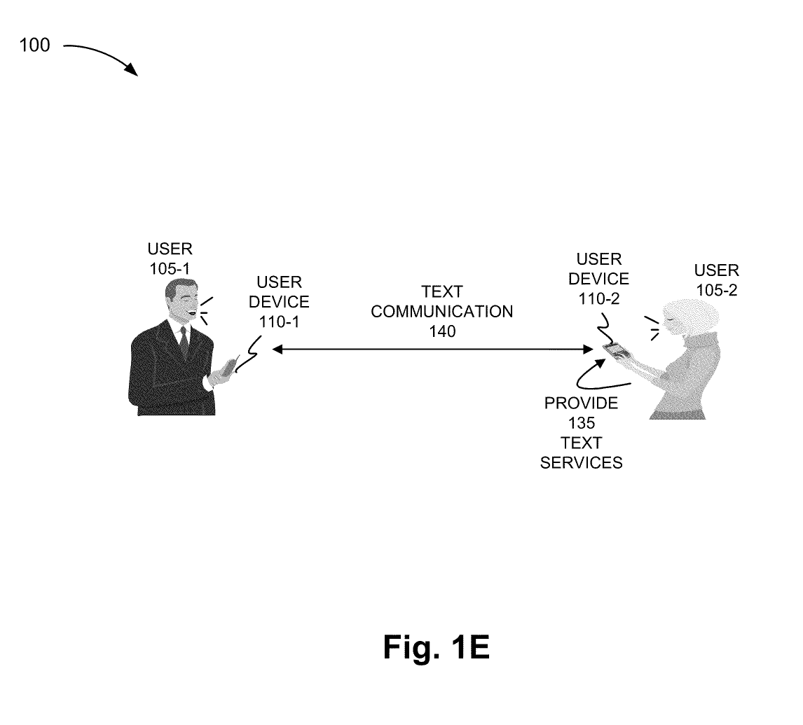

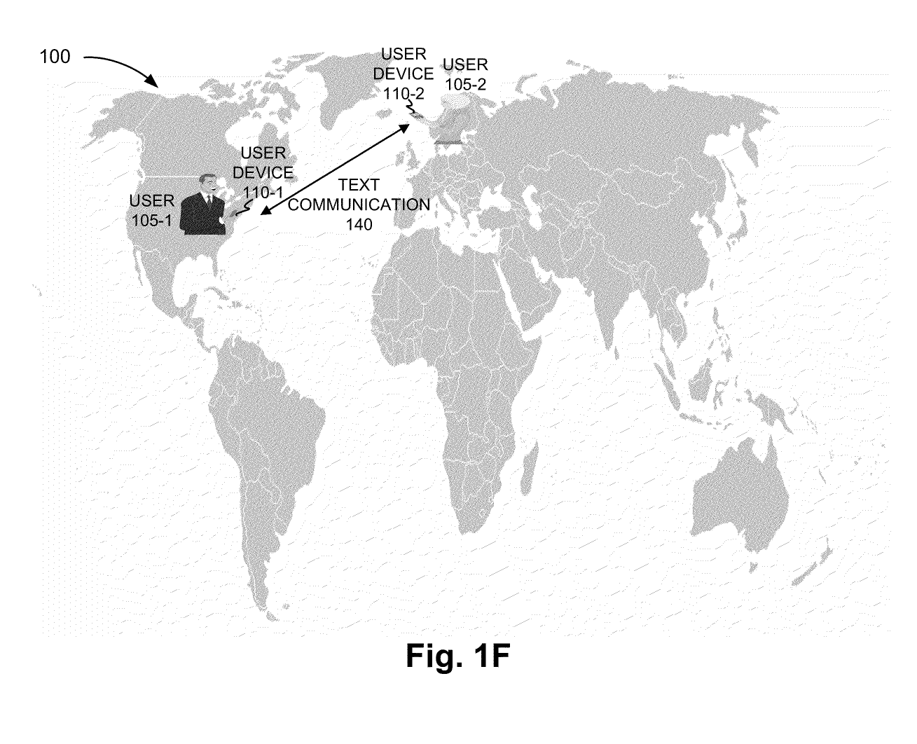

FIG. 1A is a diagram of an exemplary environment 100 in which one or more exemplary embodiments described herein may be implemented. As illustrated in FIG. 1A, environment 100 may include users 105-1 and 105-2 and user devices 110-1 and 110-2 (referred to generally as user device 110 or user devices 110). Environment 100 may include wired and/or wireless connections between user devices 110.

The number of devices and configuration in environment 100 is exemplary and provided for simplicity. In practice, environment 100 may include additional devices, different devices, and/or differently arranged devices than those illustrated in FIG. 1A. For example, environment 100 may include a network to allow users 105-1 and 105-2 to communicate with one another.

User device 110 may correspond to a portable device, a mobile device, a handheld device, or a stationary device. By way of example, but not limited thereto, user device 110 may comprise a telephone (e.g., a smart phone, a cellular phone, an Internet Protocol (IP) telephone, etc.), a PDA device, a computer (e.g., a tablet computer, a laptop computer, a palmtop computer, a desktop computer, etc.), and/or some other type of end device. User device 110 may provide text services based on language attributes, as described further below. According to an exemplary embodiment, one or more processes associated with provisioning text services based on an assignment of a language attribute to a user's contact entry may be performed automatically by user device 110. Further, according to an exemplary embodiment, user device 110 may provide a preference or options menu to allow user 105-2 to turn on or turn off this feature.

Referring to FIG. 1A, according to an exemplary scenario, user 105-2 may place a voice communication 115 to user 105-1. As illustrated, user 105-2 may reside in Sweden and user 105-1 may reside in the United States. It may be assumed that user 105-2 is multilingual. For example, user 105-2 may decide to speak English instead of Swedish. As illustrated in FIG. 1B, during voice communication 115, user device 110-2 may automatically perform a voice analysis 120 to determine the language user 105-2 is speaking Referring to FIG. 1C, once the language spoken by user 105-2 is determined, user device 110-2 may generate 125 a language attribute (e.g., a language tag, string, entry, or the like) that indicates or identifies the language.

As illustrated in FIG. 1D, user device 110-2 may automatically select and associate 130 the language attribute to a contact entry (i.e., a contact entry associated with user 105-1). For example, the contact entry may be a part of a phonebook or a contact list stored on user device 110-2. User device 110-2 may automatically select the contact entry associated with user 105-1 based on information associated with voice communication 115. For example, user device 110-2 may select the appropriate contact entry based on the outbound address (e.g., a telephone number) associated with user 105-1. The language attribute may indicate a language as being English.

Referring to FIGS. 1E and 1F, when user 105-2 decides to create a text communication 140 to user 105-1, user device 110-2 may provide 135 text services based on the language attribute associated with the contact entry of user 105-1. For example, the user interface for authoring text communication 140 may provide a script system, spell-checking, word suggestion, and auto-correction for an English-based text communication 140.

As a result of the foregoing, the multilingual user may not need to select an appropriate language for communicating a text communication to another user. Rather, user device 110 may automatically provide appropriate text services for the multilingual user based on the language attribute associated with the multilingual user's contact.

### EXEMPLARY USER DEVICE

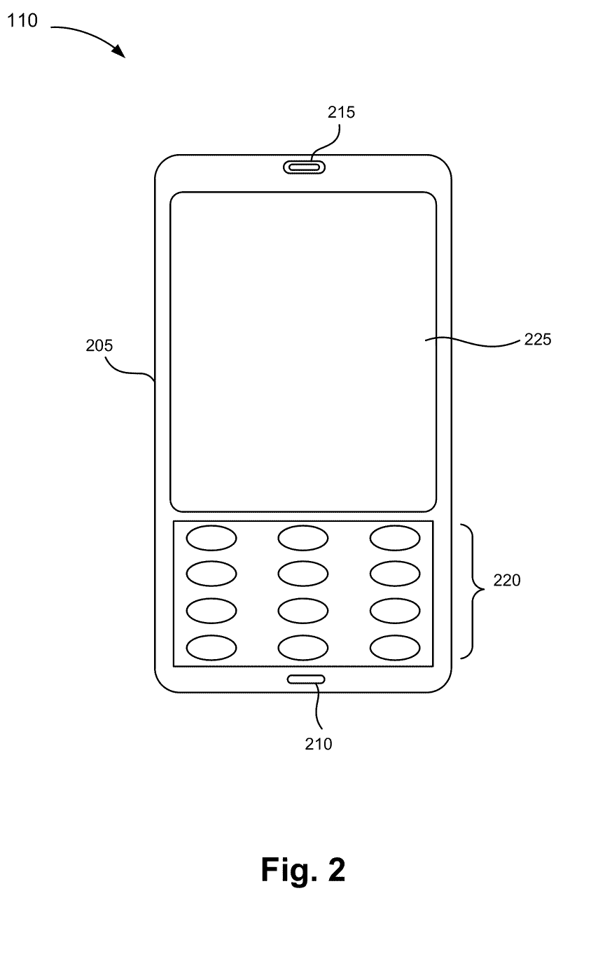

FIG. 2 is a diagram of an exemplary user device 110 in which exemplary embodiments described herein may be implemented. As illustrated in FIG. 2, user device 110 may comprise a housing 205, a microphone 210, speakers 215, keys 220, and a display 225. According to other embodiments, user device 110 may comprise fewer components, additional components, different components, and/or a different arrangement of components than those illustrated in FIG. 2 and described herein. Additionally, user device 110 may take the form of a different configuration (e.g., a slider, a clamshell, etc.) than the configuration illustrated in FIG. 2.

Housing 205 may comprise a structure to contain components of user device 110. For example, housing 205 may be formed from plastic, metal, or some other type of material. Housing 205 may support microphone 210, speakers 215, keys 220, and display 225.

Microphone 210 may transduce a sound wave to a corresponding electrical signal. For example, a user may speak into microphone 210 during a telephone call or to execute a voice command. Speakers 215 may transduce an electrical signal to a corresponding sound wave. For example, a user may listen to music or listen to a calling party through speakers 215.

Keys 220 may provide input to user device 110. For example, keys 220 may comprise a standard telephone keypad, a QWERTY keypad, and/or some other type of keypad (e.g., a calculator keypad, a numerical keypad, etc.). Keys 220 may comprise special purpose keys to provide a particular function (e.g., send, call, e-mail, etc.).

Display 225 may operate as an output component. For example, display 225 may comprise a liquid crystal display (LCD), a plasma display panel (PDP), a field emission display (FED), a thin film transistor (TFT) display, or some other type of display technology.

Additionally, according to an exemplary implementation, display 225 may operate as an input component. For example, display 225 may comprise a touch-sensitive screen. In such instances, display 225 may correspond to a single-point input device (e.g., capable of sensing a single touch) or a multipoint input device (e.g., capable of sensing multiple touches that occur at the same time). Further, display 225 may be implemented using a variety of sensing technologies, including but not limited to, capacitive sensing, surface acoustic wave sensing, resistive sensing, optical sensing, pressure sensing, infrared sensing, or gesture sensing. Display 225 may also comprise an auto-rotating function.

Display 225 may be capable of displaying text, pictures, and/or video. Display 225 may also be capable of displaying various images (e.g., icons, objects, etc.) that may be selected by a user to access various applications, enter data, and/or navigate, etc.

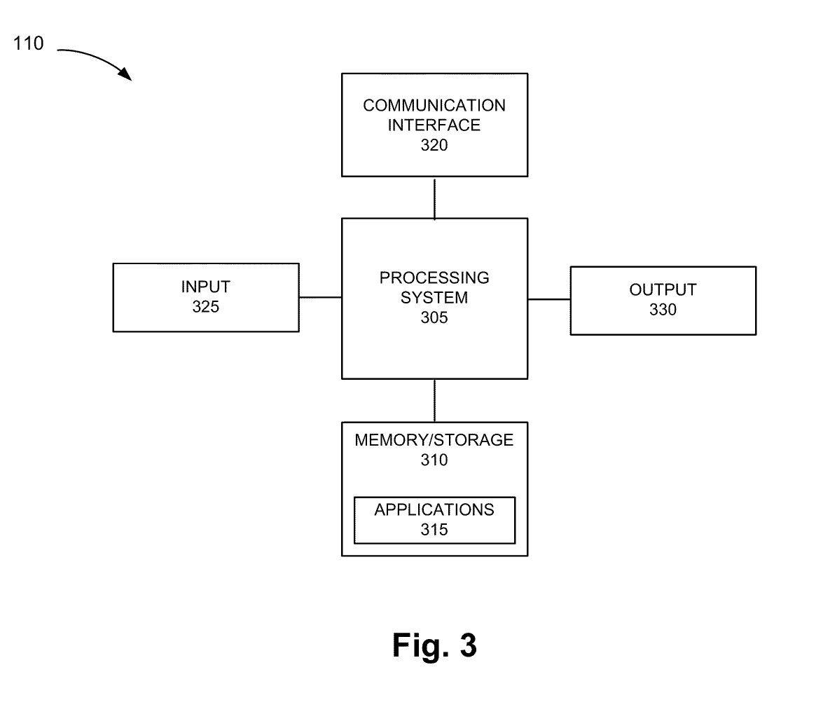

FIG. 3 is a diagram illustrating exemplary components of user device 110. As illustrated, user device 110 may comprise a processing system 305, a memory/storage 310 that may comprise applications 315, a communication interface 320, an input 325, and an output 330. According to other embodiments, user device 110 may comprise fewer components, additional components, different components, or a different arrangement of components than those illustrated in FIG. 3 and described herein.

Processing system 305 may comprise one or multiple processors, microprocessors, co-processors, application specific integrated circuits (ASICs), controllers, programmable logic devices, chipsets, field programmable gate arrays (FPGAs), application specific instruction-set processors (ASIPs), system-on-chips (SOCs), and/or some other component that may interpret and/or execute instructions and/or data. Processing system 305 may control the overall operation or a portion of operation(s) performed by user device 110. Processing system 305 may perform one or more operations based on an operating system and/or various applications (e.g., applications 315).

Processing system 305 may access instructions from memory/storage 310, from other components of user device 110, and/or from a source external to user device 110 (e.g., a network or another device).

Memory/storage 310 may comprise one or multiple memories and/or one or multiple secondary storages. For example, memory/storage 310 may comprise a random access memory (RAM), a dynamic random access memory (DRAM), a read only memory (ROM), a programmable read only memory (PROM), a flash memory, and/or some other type of memory. Memory/storage 310 may comprise a hard disk (e.g., a magnetic disk, an optical disk, a magneto-optic disk, a solid state disk, etc.) or some other type of computer-readable medium, along with a corresponding drive. Memory/storage 310 may comprise a memory, a storage device, or storage component that is external to and/or removable from user device 110, such as, for example, a Universal Serial Bus (USB) memory stick, a dongle, a hard disk, mass storage, off-line storage, etc.

The term “computer-readable medium,” as used herein, is intended to be broadly interpreted to comprise, for example, a memory, a secondary storage, a compact disc (CD), a digital versatile disc (DVD), or the like. The computer-readable medium may be implemented in a single device, in multiple devices, in a centralized manner, or in a distributed manner. Memory/storage 310 may store data, application(s), and/or instructions related to the operation of user device 110.

Memory/storage 310 may store data, applications 315, and/or instructions related to the operation of user device 110. Applications 315 may comprise software that provides various services or functions. By way of example, but not limited thereto, applications 315 may comprise a telephone application, a voice recognition application, a video application, a multi-media application, a music player application, a contacts application, a calendar application, an instant messaging application, a web browsing application, a location-based application (e.g., a Global Positioning System (GPS)-based application), a blogging application, and/or other types of applications (e.g., a word processing application, a spreadsheet application, etc.).

Applications 315 may comprise one or more applications for provisioning multilingual text communications (e.g., an e-mail application, an SMS application, an MMS application, or the like). According to an exemplary embodiment, applications 315 may open automatically to an appropriate language according to the language attribute when a user wishes to create a text communication. Applications 315 may display soft keys that may be mapped to a character or a symbol database that corresponds to the language indicated by the language attribute. Applications 315 may also provide for other text services (e.g., auto-correction, directionality, etc.) as described herein in correspondence to the language attribute.

Communication interface 320 may permit user device 110 to communicate with other devices, networks, and/or systems. For example, communication interface 320 may comprise one or multiple wireless and/or wired communication interfaces. Communication interface 320 may comprise a transmitter, a receiver, and/or a transceiver. Communication interface 320 may operate according to various protocols, communication standards, or the like.

Input 325 may permit an input into user device 110. For example, input 325 may comprise microphone 210, keys 220, display 225, a touchpad, a button, a switch, an input port, voice recognition logic, fingerprint recognition logic, a web cam, and/or some other type of visual, auditory, tactile, etc., input component. Output 335 may permit user device 110 to provide an output. For example, output 330 may comprise speakers 215, display 225, one or more light emitting diodes (LEDs), an output port, a vibratory mechanism, and/or some other type of visual, auditory, tactile, etc., output component.

User device 110 may perform operations in response to processing system 305 executing software instructions contained in a computer-readable medium, such as memory/storage 310. For example, the software instructions may be read into memory/storage 310 from another computer-readable medium or from another device via communication interface 320. The software instructions stored in memory/storage 310 may cause processing system 305 to perform various processes described herein. Alternatively, user device 110 may perform processes based on hardware, hardware and firmware, and/or hardware, software and firmware.

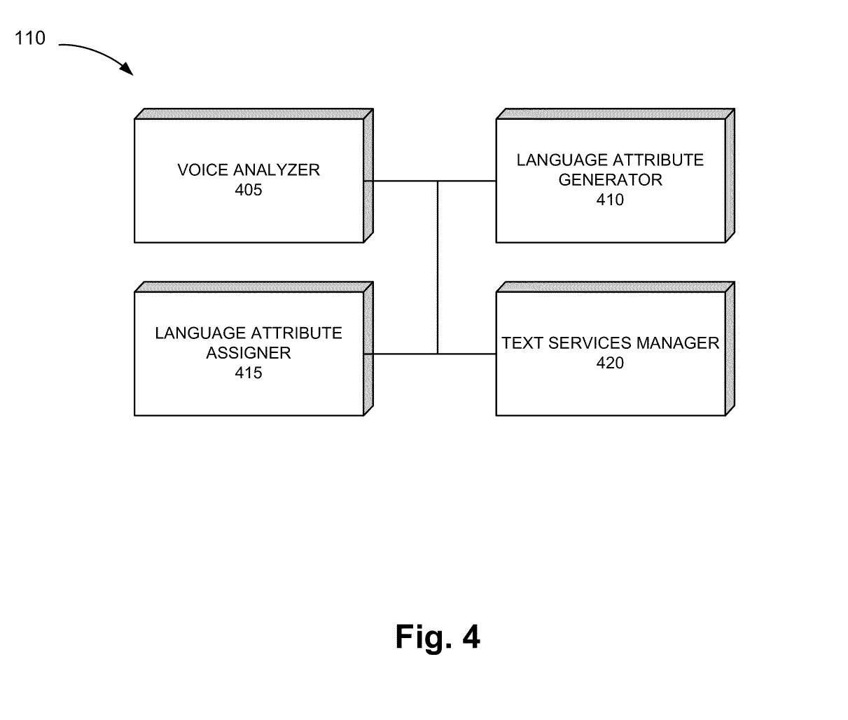

FIG. 4 is a diagram illustrating exemplary functional components of user device 110. As illustrated, user device 110 may include a voice analyzer 405, a language attribute generator 410, a language attribute assigner 415, and a text services manager 420. Voice analyzer 405, language attribute generator 410, language attribute assigner 415, and/or text services manager 420 may be implemented as a combination of hardware (e.g., processing system 305, etc.) and software (e.g., applications 315, etc.) based on the components illustrated and described with respect to FIG. 3. Alternatively, voice analyzer 405, language attribute generator 410, language attribute assigner 415, and/or text services manager 420 may be implemented as hardware, hardware and firmware, or hardware, software, and firmware based on the components illustrated and described with respect to FIG. 3.

Voice analyzer 405 may analyze a voice communication to determine a user's spoken language. For example, voice analyzer 405 may comprise a language identifier or use some other conventional method for determining a language associated with the voice communication. Voice analyzer 405 may identify multiple languages, dialects, and/or the like.

Language attribute generator 410 may generate a language attribute based on the language determined by voice analyzer 405. For example, language attribute generator 410 may generate a string (e.g., English, French, Spanish, etc.) or some other type of identifier that indicates or identifies the language.

Language attribute assigner 415 may select a contact entry and assign or associate the language attribute to the contact entry stored in user device 110. For example, language assigner 415 may select the contact entry based on information associated with the voice communication. By way of example, but not limited thereto, language attribute assigner 415 may associate an inbound voice communication address, an outbound voice communication address, a name, or the like, associated with another user and match this information to an appropriate contact entry. Language attribute assigner 415 may assign or associate the language attribute as a tag to the contact entry. Alternatively, language attribute assigner 415 may create a separate list, a separate list entry, or some other data structure that includes the language attribute. The separate list, list entry, or other data structure may be assigned or associated to the contract entry.

Text services manager 420 may provide text services based on the language attribute. For example, text services manager 420 may provide a script system (e.g., alphabetic characters, directionality (e.g., left-to-right, right-to-left, etc.), segmentation (e.g., identifying boundaries between words, etc.), etc.), and one or more of spell-checking, word suggestion, or auto-correction in accordance with the language indicated by the language attribute. For example, when the language attribute indicates the language of Spanish, text services manager 420 may provide text services in accordance with the Spanish language. According to an exemplary embodiment, text services manager 420 may be included in a multilingual text communication application (e.g., applications 315). According to another exemplary embodiment, text services manager 420 may not be included in a multilingual text communication application. Rather, text services manager 420 may indicate to a multilingual text communication application the appropriate language based on the language attribute.

Although FIG. 4 illustrates exemplary functional components of user device 110, in other implementations, user device 110 may include fewer functional components, additional functional components, different functional components, and/or a different arrangement of functional components than those illustrated in FIG. 4 and described. Additionally, or alternatively, one or more operations described as being performed by a particular functional component may be performed by one or more other functional components, in addition to or instead of the particular functional component, and/or one or more functional components may be combined.

Described below are exemplary processes performable by the functional components illustrated in FIG. 4 according to an exemplary embodiment of provisioning text services based on an assignment of a language attribute to a user's contact entry.

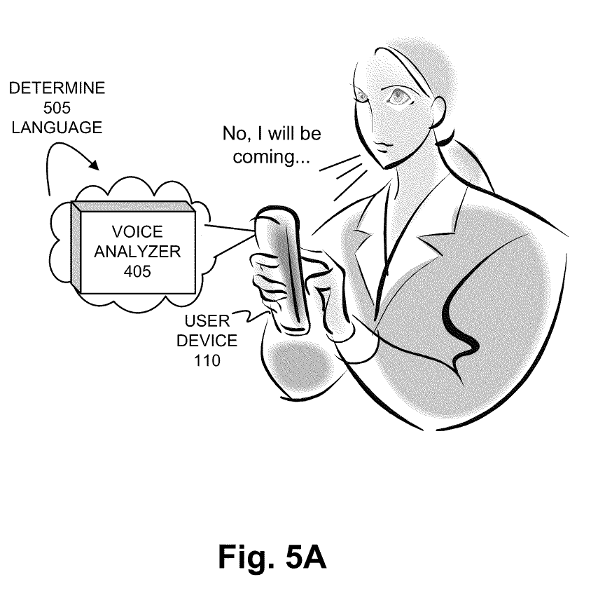

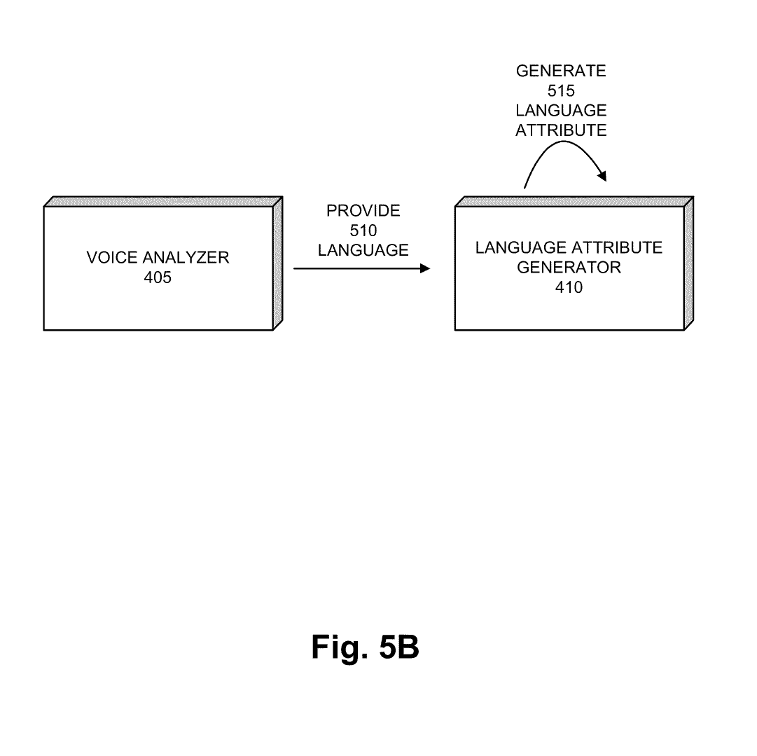

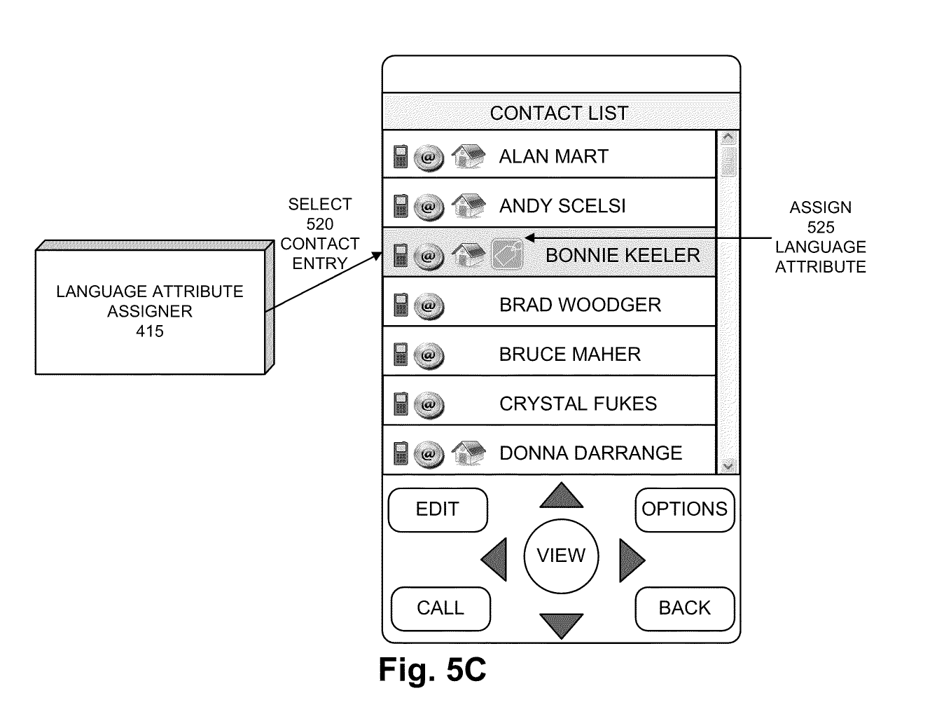

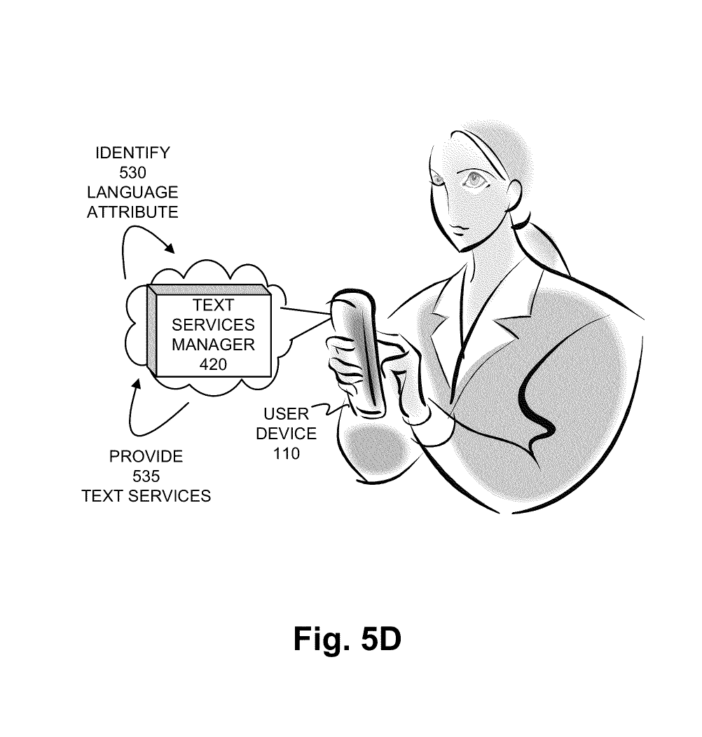

FIGS. 5A-5D are diagrams illustrating exemplary processes performed by the functional components described herein. Referring to FIG. 5A, it may be assumed that a user (i.e., a multilingual user) may receive an incoming voice communication (e.g., a telephone call) from or place an outgoing voice communication to any number of other users (not illustrated). During the user's conversation, voice analyzer 405 of user device 110 may determine 505 a language spoken by the user. In instances when the user speaks more than one language during the conversation (e.g., some words may be spoken in one language and other words may be spoken in another language; a language shift occurs during the conversation, etc.), voice analyzer 405 may select the dominant language used during the voice communication based on one or multiple factors. For example, according to an exemplary embodiment, voice analyzer 405 may consider the number of words spoken in a particular language compared to the other language(s), the language spoken by the other user(s), the geographic location of the user, and/or the geographic location or address information associated with the other user.

As illustrated in FIG. 5B, when voice analyzer 405 determines the language, voice analyzer 405 may provide 510 the determined language to language attribute generator 410. Language attribute generator 410 may generate 515 a language attribute corresponding to the determined language. For example, the language attribute may correspond to a string or some other identifier to indicate the language.

Referring to FIG. 5C, language attribute assigner 415 may select 520 the contact entry corresponding to the other user based on information associated with the voice communication. For example, language attribute assigner 415 may use the outbound address used by the user (e.g., a telephone number dialed by the user) or use the inbound address associated with an incoming voice communication (e.g., an incoming telephone call). Language attribute assigner 415 may also consider other information associated with the voice communication, such as, for example, the name of other user, etc. As further illustrated, language attribute assigner 415 may assign 525 (or associate) the language attribute to the selected contact entry. For example, language attribute assigner 415 may create a separate list, list entry, or other data structure to assign or associate the language attribute to the contact entry.

According to an exemplary embodiment, in instances when a contact entry does not already exist, user device 110 may automatically prompt the user to create a contact entry. If the user accepts, language attribute assigner 415 may assign or associate the language attribute to the newly created contact entry. If the user does not accept, language attribute assigner 415 may delete the language attribute.

As illustrated in FIG. 5D, subsequent to the voice communication, the user may wish to create a text communication to send to the other user. For example, the user may select the recipient (e.g., the other user) of the text communication by selecting the other user's contact entry and indicate a mode of communication (e.g., a text communication). According to other embodiments, the user may initiate the creation of a text communication according to other interaction with user device 110 (e.g., voice command, selecting a multilingual text communication application, etc.). According to an exemplary embodiment, text services manager 420 may identify 530 the language attribute associated with the other user once the recipient of the text communication is known or provided by the user.

According to an exemplary embodiment, text services manager 420 may provide 535 text services (e.g., a script system (e.g., alphabetic characters, directionality, segmentation (e.g., identifying boundaries between words, etc.), etc.), spell-checking, word suggestion/prediction, and auto-correction) in correspondence to the language indicated by the language attribute. By way of example, but not limited thereto, the English alphabet has 26 letters, the Swedish alphabet has 29 letters, the German alphabet has 30 letters, etc. Further, scripts have a writing direction. By way of example, but not limited thereto, English is written left-to-right, Hebrew and Arabic are written right-to-left (numbers may be written left-to-right), Japanese is written left-to-right or vertically top-to-bottom, etc.

According to another exemplary embodiment, applications 315 may provide text services based on information (e.g., the language attribute) provided by text services manager 420.

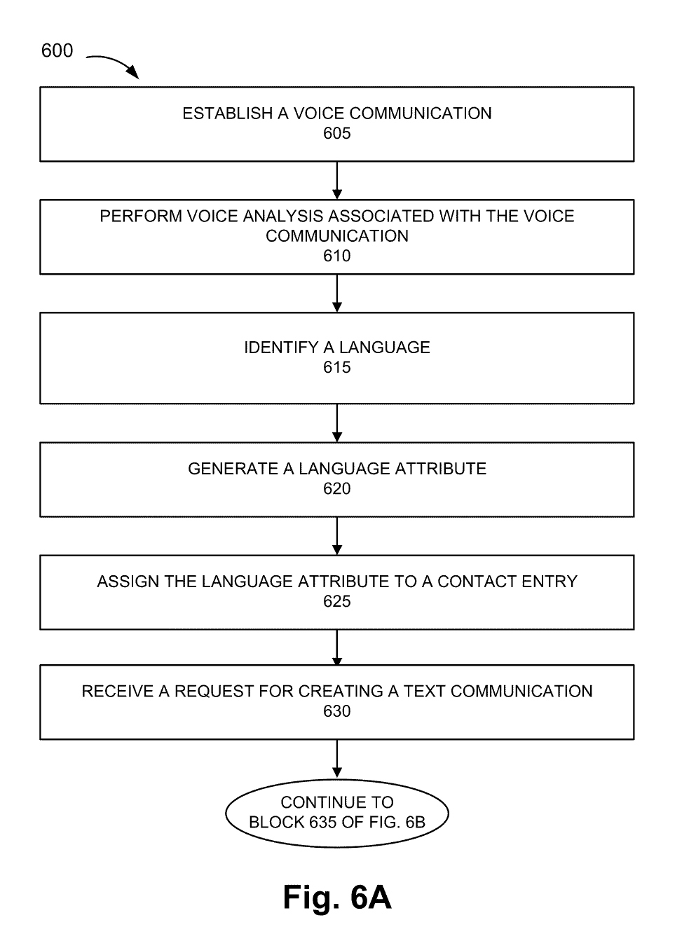

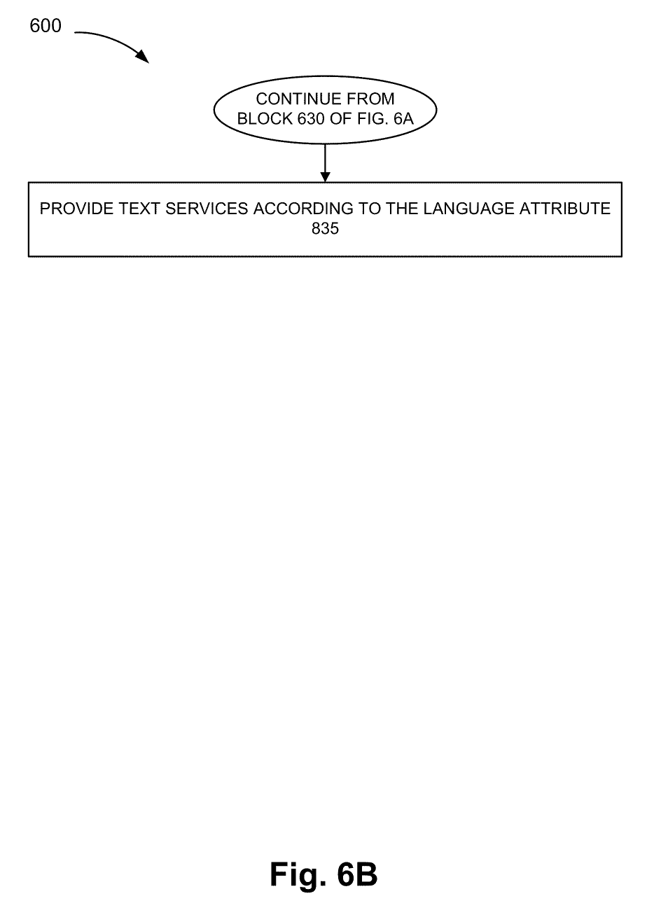

FIGS. 6A and 6B are flow diagrams illustrating an exemplary process 600 for provisioning text services based on an assignment of a language attribute to a user's contact entry. According to an exemplary implementation, process 600 may be performed by user device 110.

Process 600 may include establishing a voice communication (block 605). For example, a user may receive/send a voice communication (e.g., a telephone call, a voice chat, a voice MMS message, or the like) from/to another user using user device 110.

A voice analysis associated with the voice communication may be performed (block 610). For example, voice analyzer 405 of user device 110 may analyze the voice communication to determine a language being used (e.g., by the user). A language may be identified (block 615). For example, voice analyzer 405 of user device 110 may identify the language.

A language attribute may be generated (block 620). For example, language attribute generator 410 of user device 110 may generate a language attribute to indicate the language. For example, the language attribute may correspond to a string or some other type of tag, identifier, entry, or the like.

The language attribute may be assigned to a contact entry (block 625). For example, language attribute assigner 415 of user device 110 may select a contact entry from a contact list, phonebook, or the like, that corresponds to the other user associated with the voice communication. Language attribute assigner 415 may assign or associate the language attribute to the selected contact entry. As previously described, in instances when a contact entry does not exist, according to an exemplary embodiment, user device 110 may prompt the user to create a contact entry for the other user. According to an exemplary implementation, language attribute assigner 415 may create a separate list, a separate list entry, or some other data structure, and assign or associate it to the contact list.

A request for creating a text communication may be received (block 630). For example, user device 110 may receive a request from the user to create a text communication (e.g., an e-mail, an SMS message, an MMS message, or the like). As previously described, by way of example, but not limited thereto, the user may select the other user's contact entry from a contact list and indicate a text communication. According to other exemplary implementations, the user may initiate the creation of a text communication by opening a multilingual text communication application 315, vocalizing a voice command, etc. User device 110 may invoke text services once the recipient (e.g., the other user) is known. For example, the user may enter a telephone number associated with the other user, a name of the other user, or some other identifier or remote address (e.g., an e-mail address, etc.) associated with the other user, depending on the type of text communication, etc.

Text services may be provided according to the language attribute (block 635). For example, text services manager 420 may provide text services (e.g., a script system (e.g., alphabetic characters, directionality (e.g., left-to-right, right-to-left, etc.), segmentation (e.g., identifying boundaries between words, etc.), etc.), spell-checking, word suggestion/prediction, and auto-correction) in accordance with the language indicated by the language attribute. As previously described, according to exemplary embodiment, a multilingual text application 315 may include text services manager 420. According to another implementation, text services manager 420 may indicate to a multilingual text application 315 information relating to the language attribute so that text services are provided to the user in correspondence to the language attribute.

Although FIGS. 6A and 6B illustrate an exemplary process 600 for provisioning text services based on an assignment of a language attribute to a user's contact entry, in other implementations, process 600 may include additional operations, fewer operations, and/or different operations than those illustrated and described with respect to FIGS. 6A and 6B. In addition, while a series of blocks has been described with regard to process 600 illustrated in FIGS. 6A and 6B, the order of the blocks may be modified in other implementations. Further, non-dependent blocks may be performed in parallel.

### CONCLUSION

The foregoing description of implementations provides illustration, but is not intended to be exhaustive or to limit the implementations to the precise form disclosed. Modifications and variations are possible in light of the above teachings or may be acquired from practice of the teachings.

The terms “comprise,” “comprises,” “comprising,” as well as synonyms thereof (e.g., include, etc.), when used in the specification is taken to specify the presence of stated features, integers, steps, or components but does not preclude the presence or addition of one or more other features, integers, steps, components, or groups thereof. In other words, these terms mean inclusion without limitation.

The article “a,” “an,” and “the” are intended to mean one or more items. Further, the phrase “based on” is intended to mean “based, at least in part, on” unless explicitly stated otherwise. The term “and/or” is intended to mean any and all combinations of one or more of the listed items.

Further certain features described above may be implemented as a “component” that performs one or more functions. This component may include hardware, such as processing system 305 (e.g., one or more processors, one or more microprocessors, one or more ASICs, one or more FPGAs, etc.), a combination of hardware and software (e.g., applications 315), a combination of hardware, software, and firmware, or a combination of hardware and firmware.

No element, act, or instruction used in the present application should be construed as critical or essential to the implementations described herein unless explicitly described as such.

What is claimed is:

1. A method comprising:
establishing, by a user device, a voice communication with another user;
performing voice analysis to determine a language being used by a user during the voice communication;
generating, by the user device, a language attribute that indicates the language;
assigning or associating, by the user device, the language attribute to a contact entry associated with the other user;
receiving, by the user device, a request to create a text communication to the other user; and
providing, by the user device, text services corresponding to the language attribute associated with the other user, wherein the text services include a script system to permit the user to create the text communication.

2. The method of claim 1, further comprising:
selecting the contact entry based on an inbound communication address or an outbound communication address associated with the other user.

3. The method of claim 1, wherein the providing comprises:
providing one or more of auto-correction, word prediction, or spell checking in accordance with the language attribute.

4. The method of claim 1, wherein the providing comprises:
providing the text services as a part of a multilingual text communication application.

5. The method of claim 1, wherein the text communication comprises one of an email, a simple messaging service message, or a multimedia messaging service message.

6. The method of claim 1, further comprising:
creating a contact entry associated with the other user when one does not already exist.

7. The method of claim 1, wherein the voice communication comprises one of a telephone call, a voice chat, or a voice multimedia messaging service message.

8. The method of claim 1, wherein the script system comprises an alphabetic and directionality system corresponding to the language attribute.

9. A user device comprising components configured to:
perform voice analysis to determine a language being used by a user during a voice communication with another user;
generate a language attribute that indicates the language;
assign or associate the language attribute to a contact entry associated with the other user;
receive a request to create a text communication to the other user; and
provide a script system in correspondence to the language attribute to permit the user to create the text communication in the language.

10. A user device of claim 9, wherein the user device comprises a radio telephone.

11. The user device of claim 9, wherein when performing voice analysis the components are configured to:
determine the language even when the user speaks more than one language during the voice communication.

12. The user device of claim 9, wherein the components are further configured to:
store a contacts list;
create a separate list entry corresponding to the language attribute; and
select the contact entry from the contact list based on an inbound communication address or an outbound communication address associated with the other user.

13. The user device of claim 9, wherein the text communication comprises one of an e-mail, a simple messaging service message, or a multimedia messaging service message.

14. The user device of claim 9, wherein the components are further configured to:
perform voice analysis to identify a language being used by the other user.

15. The user device of claim 9, wherein the components are further configured to:
create a contact entry associated with the other user when one does not already exist.

16. The user device of claim 9, wherein the components are further configured to:
provide one or more of auto-correction, word prediction, or spell checking in accordance with the language attribute.

17. A computer-readable medium containing instructions executable by at least one processing system, the computer-readable medium storing instructions to:
perform voice analysis to determine a language being used by a user during a voice communication with another user;
generate a language attribute that indicates the language;
assign or associate the language attribute to a contact entry associated with the other user;
receive a request to create a text communication to the other user; and
provide text services in correspondence to the language attribute to permit the user to create the text communication in the language.

18. The computer-readable medium of claim 17 further storing one or more instructions to:
store a contacts list;
store a language attribute list; and
select the contact entry from the contact list.

19. The computer-readable medium of claim 17, further storing one or more instructions to:
provide the text services as a part of a multilingual text communication application.

20. The computer-readable medium of claim 17, wherein a user device in which the computer-readable medium resides comprises a radio telephone.
